(19) United States
(12) Patent Application Publication
(10) Pub. No.: US 2023/0032757 A1
(43) Pub. Date: Feb. 2, 2023

(54) ELECTRIC PLUG CONNECTOR WITH BENDING GUARD

(71) Applicant: HARTING ELECTRONICS GMBH, Espelkamp (DE)

(72) Inventors: Marc GENAU, Luebbecke (DE); Maximilian ROHRER, Bielefeld (DE)

(21) Appl. No.: 17/758,629

(22) PCT Filed: Feb. 8, 2021
(86) PCT No.: PCT/DE2021/100122

§ 371 Date: Jul. 11, 2022

(30) Foreign Application Priority Data
Feb. 17, 2020 (DE) 10 2020 104 035.0

(51) Int. Cl. H01R 13/58

(52) U.S. Cl. CPC H01R 13/582

(57) ABSTRACT

An electric plug connector has a locking element configured for releasably connecting to a mating plug connector, a housing for receiving at least one cable and at least one contact element, and a bending guard which is made of an elastic material and prevents excessive bending of the connected cable, wherein the bending guard can be used for different cable cross-sections for field assembly.

The invention is based on an electric plug connector having a strain relief according to the generic type of the independent claim 1.

Plug connectors of this type are required in order to connect lines, in particular cables for transmitting electrical currents, signals and data, to device connections or corresponding plug connectors.

### PRIOR ART

It is usual in the prior art to use different types of bending protection, also referred to as a kink protection, in order during the operational use to prevent the lines that are connected by means of the plug connector from twisting or excessively bending and in the worst case scenario from becoming kinked. These stresses can cause damage to the line, the contact elements of the plug connector, the plug connector as a unit or in the worst case scenario to the connected device. Furthermore, bending protections are often additionally formed in such a manner that they act as a strain relief. Strain reliefs provide relief for the connectors, the lines in the cable and the connected contact elements during a tensile stress, which can occur, for example, unintentionally due to moving elements such as industrial trucks, people or similar circumstances, or also due to normal operational movement sequences of a device that is coupled to the plug connector, for example a connected work machine.

In the prior art, a corresponding element is in most cases molded onto the cable outlet of a plug connector, usually by means of an overmolding process, in order to implement bending protection. However, these methods are comparatively costly and complex. Furthermore, a corresponding cable or the required plug connector cannot be attached by the user/customer.

In the case of plug connectors that can be assembled in the field, the prior art in most cases discloses cable glands. In this case, sealing elements, for example synthetic material seals or rubber seals are clamped between the cable and the housing of the electrical plug connector by means of a nut having a cut-out for the cable.

EP 3 132 506 B1 discloses a cable outlet for assembling on a cable outlet connecting piece of a device, housing or plug connector. In this case, a curable polymer is provided on the inner face of the cable outlet and said curable polymer connects the cable outlet and the plug connector and an inserted cable to one another in a mechanical manner.

U.S. Pat. No. 2,027,962 A claims a method for producing objects having a synthetic material composition, at least in part consisting of a thermoplastic resin material, comprising producing a blank from the synthetic material composition and subjecting the blank to a heat treatment in order to cause it to change its physical form and to adopt its final form and become heat-stable.

Fundamentally, for the field assembly of plug connectors having cables that are to be connected, the prior art renders possible either a professional looking connection but only for predetermined cable cross-sections or a less professional looking connection that in contrast can be used for different cable cross-sections. However, in the event of improper or careless use, the known screw connections or screw seals can damage the cable or the cores in the cable.

During the priority application regarding the current application, the German Patent and Trademark Office has researched the following prior art: DE 10 2014 105 442 A1, CN 108 321 653 A, US 2017/0227401 A1, CN 2 842 794 Y, DE 10 2015 219 654 A1 and DE 10 2015 221 898 A1.

### Object of the invention

The object of the invention is to provide a visually attractive cable connection to a plug connector that can be assembled in the field and that can accommodate and seal different cable cross-sections.

The object is achieved by means of the subject of the independent claims.

Advantageous embodiments of the invention are disclosed in the dependent claims and the description below.

The invention relates to an electric plug connector, comprising a locking element for the releasable connection to a mating plug connector, a housing for receiving at least one cable, at least one contact element and a bending protection. The bending protection is manufactured from an elastic material and prevents the connected cable from bending excessively. In this case, a connecting element is arranged between the housing and the bending protection, wherein the connecting element can assume at least a first state and a second state, wherein at least the second state is irreversible. The bending protection is permanently fixed to the cable-side end of the housing by means of the connecting element, wherein the connecting element is in the second state for fixing purposes. Alternatively, the bending protection is irreversibly fixed to the cable by means of the connecting element with the result that the bending protection is directly connected to the housing of the plug connector. In other words, during an assembly procedure the bending protection and the connecting element are pushed onto the cable. In this case, the connecting element is in its first state, the assembly state. The cable or at least one core of the cable is subsequently provided with at least one contact element and inserted into the housing. It is naturally also possible to connect the cable to the contact element prior to attaching the bending protection and/or the connecting element. The connecting element can now be guided to the cable-side end of the housing and the bending protection is pushed over the connecting element and onto the cable-side end of the housing. The connecting element is advantageously designed as one piece. The bending protection is likewise ideally designed as one piece. Once the bending protection has been arranged on the cable-side end of the housing, the connecting element is transferred from a first state, the assembly state, into a second state, the operational state. In the operational state, in other words the second state of the connecting element, the connecting element provides an irreversible connection of the bending protection, cable and the housing of the electric plug connector.

In an expedient embodiment, a change of state of the connecting element is triggered by a temperature change of more than 50° C. In this case, it appears to be particularly expedient to select for the connecting element at least one component that triggers the change of state by heating the connecting element to a temperature of above 100° C. This temperature change is to prevent in particular an undesired activation of the component of the connecting element. The desired temperature stability is realized above all by the use or thermoplastic synthetic materials. Fundamentally, the temperature for activating the change of state of the connecting element can be influenced by the composition of the synthetic material. In order to ensure that the plug connector can be assembled in the field, a temperature should be selected that can be realized with little effort, for example by means of a hot air gun. Furthermore, it appears to be logical to manufacture the housing and also the bending protection from a material that without becoming damaged survives at least the temperature for activating the connecting element.

A further embodiment provides to manufacture the connecting element from at least two components that are activated by heat and assume the second state, in other words the operational state. In an efficient manner, at least one of the components of the connecting element in so doing develops an adhesive effect as soon as the change of state from the at least first state into the at least second state is triggered. In this manner, it is possible, in addition to a mechanical connection of the housing to the bending protection and the cable, to produce a material-bonded connection by means of the connecting element. An additional material-bonded connection would have the particular advantage of ensuring a reliable protection with regard to the penetration of foreign bodies, for example dust and/or water.

One embodiment provides for the change of state of the connecting element from the first state into the second state to be carried out in the form of an irreversible expansion. For this purpose, the connecting element is designed for example in the form of an O-ring made from expanded synthetic material, for example from a polyurethane. Comparable to applications in the construction industry, a foam-forming polyurethane is selected, for example, which creates a particularly advantageous connection between the components of the electrical connector, in other words the housing, the cable and the bending protection. This embodiment appears particularly interesting as a retrofit solution, in which a bending protection in accordance with the invention is applied to an already manufactured, corresponding housing of an electrical connector, wherein the housing has a thread on the cable side. As soon as the foam or a similarly expanding material of the connecting element is activated, it can expand between the threads and the bending protection in order in this way to form a particularly advantageous connection having a sealing function.

An alternative embodiment of the invention proposes an electric plug connector, comprising a locking element for the releasable connection to a mating plug connector, a housing for receiving at least one cable and at least one contact element and a bending protection. The bending protection is manufactured from an elastic material and prevents the connected cable from bending excessively. In this case, the bending protection assumes at least a first state and a second state, wherein at least the second state is irreversible. During the second state, the bending protection is permanently fixed to the cable-side end of the housing. In order to form such a bending protection, it is proposed to first crosslink a plastic in a desired and sensible form. The electron beam crosslinking process is usually used for this purpose. After the crosslinking process, the material, for example a thermoplastic such as polyethylene or polybutene, is expanded under the influence of heat. In this context, the expanded state is understood to be the first state of the bending protection. Subsequently, the bending protection that is manufactured in this way is guided to the housing of the electrical connector and transferred into its operational state, in other words the second state according to the invention.

In one logical embodiment, this change of state of the bending protection is triggered by a temperature change of more than 50° C. In this case, it appears to be particularly expedient to select for the bending protection of the electric plug connector at least one material whose change of state is triggered by heating the bending protection to a temperature of above 100° C. This temperature change is to prevent in particular an undesired activation of the material of the bending protection. This temperature stability is realized primarily by the use or composition of thermoplastic synthetic materials. Fundamentally, the temperature can be influenced by the composition of the synthetic material so as to activate the change of state of the connecting element. In order to ensure that the plug connector can be assembled in the field, a temperature should be selected that can be realized with little effort, for example by means of a hot air gun. Furthermore, it appears to be logical to manufacture the housing from at least a material that without becoming damaged survives at least the temperature for activating the connecting element.

Another embodiment of the electrical plug connector having a bending protection in accordance with the invention provides for the bending protection to be manufactured from at least two components that are activated by heat and assume the second state. In this case, it appears to be particularly advantageous that at least one of the components of the bending protection develops an adhesive effect as soon as the change of state from the at least first state into the at least second state is triggered. In this manner, it is possible in addition to a mechanical connection of the housing to the bending protection and the cable to produce a material-bonded connection by means of the second component. An additional material-bonded connection would have the particular advantage of ensuring a reliable protection with regard to the penetration of foreign bodies, for example dust and/or water. Furthermore, a strain relief is realized in addition to the effect of the sealing arrangement and of the bending protection. This means that the cable that is used and the electrical connector are less susceptible to damage as a result of tensile stress. These tensile stresses can occur both unintentionally, for example as a result of an accident. Likewise, tensile stresses of this type can occur intentionally, for example as a result of movements during the operation of a work machine.

An efficient embodiment provides that the bending protection has a fundamentally hollow-cylindrical form that tapers conically running from the cable-side end of the housing to the cable. In this case, the bending protection is provided with cut-outs which to a limited extent allow and/or enable the cable to bend without becoming damaged. A visually appealing form which resembles for example an overmolded bending protection can generally be realized by means of these cut-outs. Furthermore, a similarly positive bending protection, for example a kink protection, is realized as in the case of an overmolded bending protection but with the sealing effect of a shrink tube.

Furthermore, an expedient embodiment provides for the bending protection to be designed in a form which forms an angle. Angles of fundamentally 45° are particularly efficient in this case. Moreover, an angle of at least 90° C. is efficient. Depending upon the field of application of the electric plug connector, other angles can also be desired.

### EXEMPLARY EMBODIMENT

An exemplary embodiment of the invention is illustrated in the drawings and is explained in detail below. In the drawings:

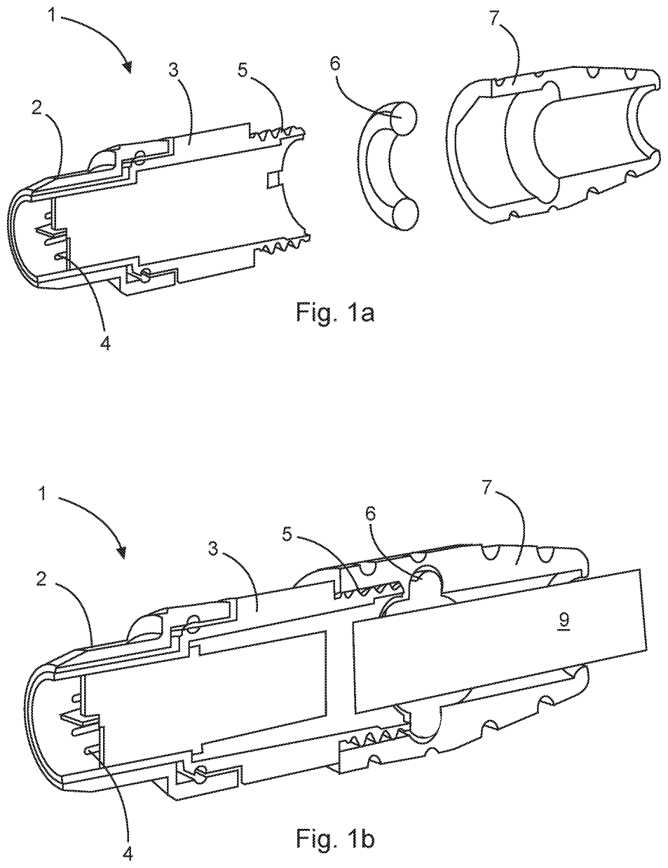

FIG. 1a illustrates an exploded view of an electric plug connector in accordance with the invention with a bending protection,

FIG. 1b illustrates a perspective view of an electric plug connector in accordance with the invention with an expanded connecting element,

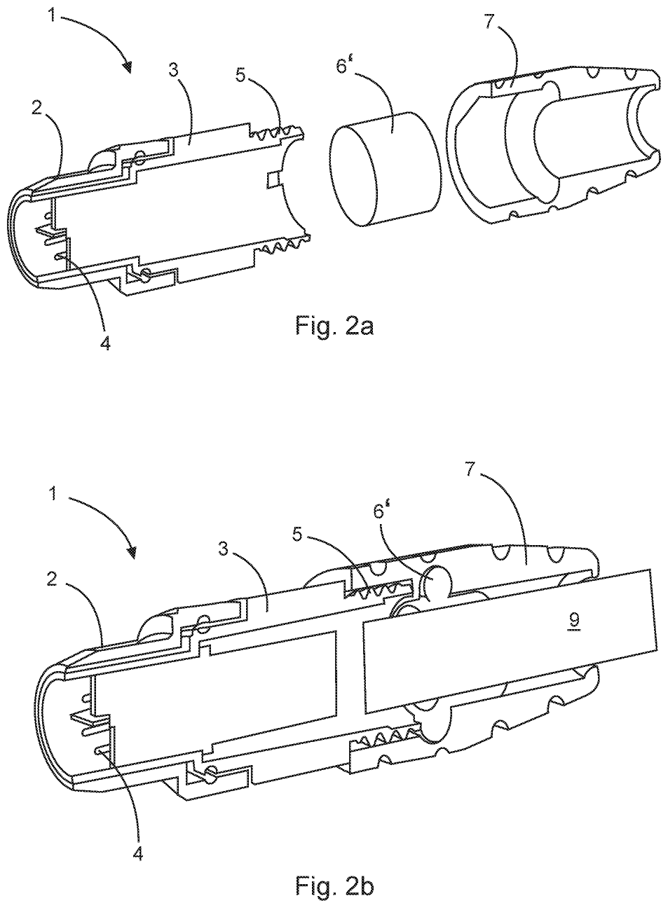

FIG. 2a illustrates an exploded view of an alternative electric plug connector in accordance with the invention with a bending protection,

FIG. 2b illustrates a perspective view of an alternative electric plug connector in accordance with the invention with an expanded connecting element,

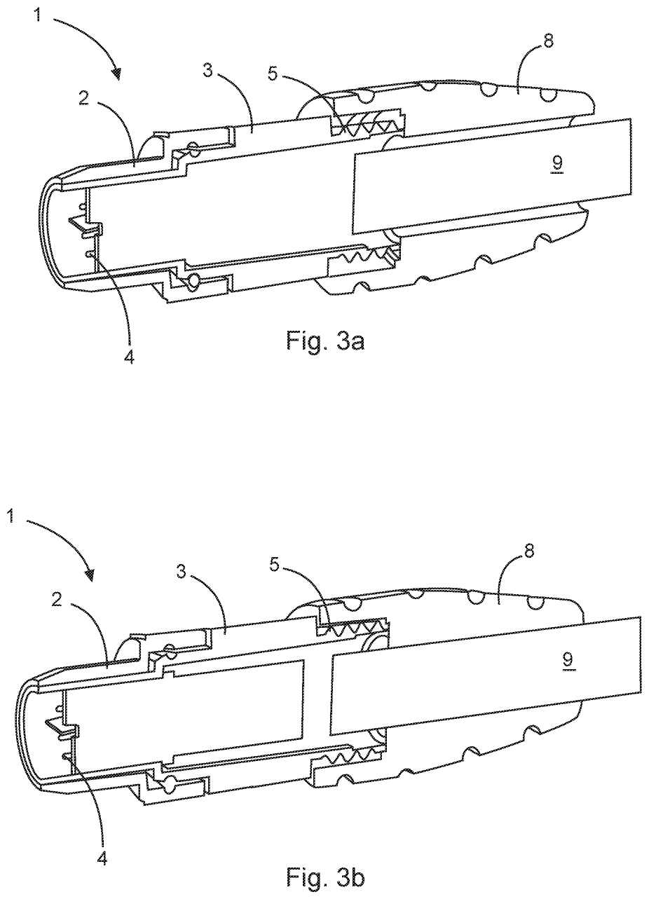

FIG. 3a illustrates a perspective view of an electric plug connector in accordance with the invention with a bending protection in accordance with the invention in a first state,

FIG. 3b illustrates a perspective view of an electric plug connector in accordance with the invention with a bending protection in accordance with the invention in a second state,

The figures show in part simplified schematic illustrations. In part, identical reference numerals are used for similar but possibly not identical elements. Different views of the same elements may be scaled differently. Directions such as “top”, “bottom”, “left”, “right”, “front” and “back” refer to the respective illustrations and may vary in relation to the elements shown.

FIG. 1a illustrates an electric plug connector 1 in accordance with the invention in an in part exploded view. In this case, the electric plug connector 1 is illustrated in FIG. 1a with a locking element 2, a housing 3 and some contact elements 4 arranged therein in combination. The housing 3 is provided in this case on its cable-side end with a thread 5 with the result that it is possible to use cable glands that are usually used in the prior art. A connecting element 6 in accordance with the invention in the form of an O-ring is arranged between a cable-side end of the housing 3 and a bending protection 7 in accordance with the invention. The bending protection 7 is designed in this case as a hollow cylindrical body having a housing-side inner diameter that can be guided over the outer-lying thread 5 of the housing 3. In the illustration, the connecting element 6 is in a first state.

In FIG. 1b, the plug connector 1 in accordance with the invention is shown in a fully assembled illustration. In this case, the bending protection 7 is guided over a cable 9 that is connected in the housing 3 to the contact elements 4. The bending protection 7 is guided over the thread 5 and by virtue of the activation of the synthetic material of the connecting element 6, said bending protection is expanded as illustrated. The activation is performed in accordance with the invention by supplying heat, for example using a heat gun. Alternatively, it is possible to use for the activation a further component that is arranged for example in a reservoir in the bending protection 7 or is inserted via the cable-side opening of the bending protection 7. In accordance with the invention, the activation causes an irreversible expansion of the connecting element 6 with the result that the connecting element 6 is in a second state, the operating state, in FIG. 1b. The connecting element 6 advantageously expands in such a way that at least a part of the thread 5 is also sealed by the connecting element 6. In FIG. 2, the expanded connecting element 6 produces a material-bonded connection between the housing 3 and the bending protection 7.

FIG. 2a and FIG. 2b illustrate a comparable construction such as in the previously mentioned FIG. la and FIG. lb but a hollow cylindrical connecting element 6′ is used in lieu of a connecting element 6 that is in the form of an O-ring. Comparable to the connecting element 6, the connecting element 6′ can develop a sealing effect through expansion, as well as create a positive-locking or material-bonded connection between the cable-side end of the housing 3 and the bending protection 7.

An alternative embodiment of the invention is illustrated in FIG. 3a and FIG. 3b. In this embodiment, the bending protection 8 is designed as a shrinkable molded element. As a result, in particular a connecting element 6 such as illustrated in alternative embodiments can be omitted. Efficient crosslinking of the materials in the bending protection 8, for example by means of the method of electron beam crosslinking, can achieve a form that retains its shape even after activation of the bending protection 8, for example by supplying heat. As a result, a connection of the cable 9 and housing 3 of the electric plug connector 1 is produced which also leaves a visually professional impression. FIG. 3a shows the form of the bending protection 8 on the housing 3 of the electric plug connector 1, said bending protection having been expanded after the electron beam crosslinking process. In this case, the cable 9 is encompassed by the bending protection 8. Polyethylene and/or polybutene are particularly suitable as a material for this. The bending protection 8 can in its expanded form, in other words in its first state, be guided over the cable-side end of the housing 3, in other words it is possible to cover an existing thread 5. By virtue of transferring the bending element 8 from its first state into its second state illustrated in FIG. 3b, the thread 5 can be used as a particularly advantageous fixing arrangement of the bending protection 8 on the housing. A further advantage of the bending protection 8 that is formed in this manner is the ability to receive different cross-sections of cables 9 having a similar bending protection 9. This means that the illustrated cable 9 can be designed for example both with a 10 mm² cross-section area and also with a 5 mm² cross-section area and yet be equally reliably accommodated and sealed by the bending protection 9 in accordance with the invention. An efficient further development provides to coat the inner face of the embodiment of the bending protection 8 that is illustrated in FIGS. 3a and 3b with an adhesive material. Even more advantageously, a material is used which acquires an adhesive effect when the bending element 8 is activated from a first state into a second state.

Even if different aspects or features of the invention are illustrated in the figures in each case in combination, it is obvious to the person skilled in the art—unless otherwise indicated—that the illustrated and discussed combinations are not the only possible combinations. In particular, units or feature complexes of different exemplary embodiments that correspond to one another may be exchanged with one another.

### Electric plug connector with bending guard

### LIST OF REFERENCE NUMERALS

1 Electric plug connector
2 Locking element
3 Housing
4 Contact element
5 Thread
6, 6′ Connecting element
7 Bending protection
8 Bending protection
9 Cable

1. An electric plug connector comprising a housing for receiving at least one cable and a bending protection that is manufactured from an elastic material and prevents the connected cable from bending excessively and wherein a connecting element is arranged between the housing and the bending protection,
wherein
the connecting element is configured to assume at least a first state and a second state, wherein at least the second state is irreversible and that
the bending protection is permanently fixed to the cable-side end of the housing by the connecting element, wherein the connecting element is in the second state.

2. The electrical plug connector as claimed in claim 1, wherein
a change of state of the connecting element is triggerable by a temperature change of more than 50° C.

3. The electrical plug connector as claimed in claim 1, wherein
a change of state is triggerable by heating the connecting element to a temperature above 100° C.

4. The electric plug connector as claimed in claim 1 wherein
the connecting element comprises at least two components that are configured to be activated by heat and assume the second state.

5. The electric plug connector as claimed in claim 1 wherein
at least one of the components of the connecting element is configured to develop an adhesive effect as soon as the change of state from the at least first state into the at least second state is triggered.

6. The electric plug connector as claimed in claim 1 wherein
the change of state of the connecting element from the first state into the second state is an irreversible expansion.

7. An electric plug connector comprising a housing configured for receiving at least one cable and a bending protection that is manufactured from an elastic material and is configured to prevent the connected cable from bending excessively and wherein the bending protection is configured to assume at least a first state and a second state, wherein at least the second state is irreversible,
wherein
the bending protection is permanently fixed to the cable-side end of the housing, wherein the bending protection is in the second state.

8. The electric plug connector as claimed in claim 7, wherein
a change of state of the bending protection is triggered by a temperature change of more than 50° C.

9. The electric plug connector as claimed in claim 7, wherein
a change of state is triggered by heating the bending protection to a temperature above 100° C.

10. The electric plug connector as claimed in claim 7 wherein
the bending protection comprises at least two components that are configured to be activated by heat and assume the second state.

11. The electric plug connector as claimed in claim 7 wherein
at least one of the components of the bending protection is configured to develop an adhesive effect as soon as the change of state from the at least first state into the at least second state is triggered.

12. The electric plug connector as claimed in claim 7 wherein
the bending protection has a fundamentally hollow cylindrical form that tapers conically running from the cable-side end of the housing towards the cable and is provided with cut-outs that to a limited extent is configured to allow and/or render possible the cable to bend.

13. The electric plug connector as claimed in claim 2, wherein the connecting element comprises at least two components that are configured to be activated by heat and assume the second state.

14. The electric plug connector as claimed in claim 2, wherein at least one of the components of the connecting element is configured to develop an adhesive effect as soon as the change of state from the at least first state into the at least second state is triggered.

15. The electric plug connector as claimed in claim 2, wherein the change of state of the connecting element from the first state into the second state is an irreversible expansion.

16. The electric plug connector as claimed in claim 8, wherein the bending protection comprises at least two components that are configured to be activated by heat and assume the second state.

17. The electric plug connector as claimed in claim 8, wherein at least one of the components of the bending protection is configured to develop an adhesive effect as soon as the change of state from the at least first state into the at least second state is triggered.

18. The electric plug connector as claimed in claim 8, wherein the bending protection has a fundamentally hollow cylindrical form that tapers conically running from the cable-side end of the housing towards the cable and is provided with cut-outs that to a limited extent is configured to allow and/or render possible the cable to bend.
